(19) United States
(12) Patent Application Publication
(10) Pub. No.: US 2009/0241715 A1
(43) Pub. Date: Oct. 1, 2009

(54) RANGE SHIFTING APPARATUS

(75) Inventors: Michimasa TANAKA, Kariya-shi (JP); Shinichiro Hazama, Toyota-shi (JP); Tatsuya Ishikawa, Anjo-shi (JP)

Correspondence Address: SUGHRUE MION, PLLC, 2100 PENNSYLVANIA AVENUE, N.W., SUITE 800, WASHINGTON, DC, 20037, US

(73) Assignees: AISIN AW CO., LTD., Anjo-shi (JP); AISIN SEIKI KABUSHIKI KAISHA, Kariya-shi (JP)

(21) Appl. No.: 12/412,911

(22) Filed: Mar. 27, 2009

(30) Foreign Application Priority Data
Mar. 28, 2008 (JP) 2008-088298

(51) Int. Cl. F16H 61/28

(52) U.S. Cl. 74/473.12

(57) ABSTRACT

A range shifting apparatus which achieves a predetermined shift range selected from a plurality of shift ranges by shifting a range shifting member on the basis of an electric signal, the apparatus including a motor controlled on the basis of a signal from a range selecting mechanism which selects the shift ranges; a converting mechanism which converts a rotational drive force of the motor to a drive force of a linear movement; and an arm member for converting the drive force of the linear movement converted by the converting mechanism into a drive force of a pivotal movement, wherein the motor is arranged between the converting mechanism and a proximal portion of the arm member, which is a pivotal center of the pivotal movement.

### CROSS REFERENCE TO RELATED APPLICATION

The disclosure of Japanese Patent Application No. 2008-88298 filed on Mar. 28, 2008 including the specification, drawings and abstract is incorporated herein by reference in its entirety.

### BACKGROUND OF THE INVENTION

1. Field of the Invention

The present invention relates to a range shifting apparatus including a shift-by-wire system that sets a shift range (for example, P, R, N, D) selected by a driver using, for example, a shift lever via electric signals.

2. Description of Related Art

For example, the shift range of a vehicle having an automatic transmission is normally set by a driver by operating a shift lever to move a manual valve thereby switching oil channels. In this case, a system of a range shifting apparatus in which the shift range selected by the driver is set via electric signals, not via a mechanical wire or rod, is known as a shift-by-wire (SBW) system.

A range shifting apparatus using the shift-by-wire system, configured to drive an electric motor via electric signals on the basis of the operation of the shift lever, convert a rotational force of the electric motor to a linear movement by a transmission mechanism including a screw mechanism, and convert the linear movement into a rotational movement of a manual shaft via a lever member is proposed (see JP 2004-513307A, hereinafter referred to as Patent Document 1). Then, the rotational movement of the manual shaft is transmitted to the manual valve via a detent mechanism or the like where by the manual valve is activated and the shift range is transferred.

However, the range shifting apparatus shown in Patent Document 1 has a screw shaft of a screw mechanism and a revolving shaft of the electric motor arranged on the same axis, so that the axial length is increased. Therefore, there arises a problem such that the range shifting apparatus has a large size and hence the position for arrangement is limited, so that reducing the size of the range shifting apparatus is desired.

### SUMMARY OF THE INVENTION

Accordingly, an object of the present invention is to provide a range shifting apparatus which is able to have a reduced size due to the layout of the respective components.

An aspect of the present invention (see FIG. 1 to FIGS. 3A and 3B, for example) provides a range shifting apparatus (1) which achieves a predetermined shift range selected from a plurality of shift ranges (P, R, N, D) by shifting a range shifting member (21) on the basis of an electric signal (SI) including:

a motor (4) controlled on the basis of a signal from range selecting means (2) which is capable of selecting the shift ranges;

a converting mechanism (5) which converts a rotational drive force of the motor (4) to a drive force of a linear movement; and

an arm member (6) for converting the drive force of the linear movement converted by the converting mechanism (5) into a drive force of a pivotal movement,

wherein the motor (4) is arranged between the converting mechanism (5) and a proximal portion (6A) as a pivotal center of the pivotal movement of the arm member (6).

Accordingly, since the motor is arranged between the proximal portion of the arm member and the converting mechanism and an axial direction of the converting mechanism and the axial direction of the motor are arranged in parallel, the axial lengths may be reduced, and hence the size of the range shifting apparatus is reduced.

Also, since the length of the arm member is set to be longer by the radial dimension of the motor than, for example, the case in which the proximal portion of the arm member and the converting mechanism are arranged adjacently, a large amount of the linear movement of the converting mechanism is secured for the pivotal angle of the proximal portion, and hence the pivotal angle of the proximal portion can be controlled with high degree of accuracy. In addition, the torque inputted to the converting mechanism is reduced by an amount corresponding to the increase of the length of the arm member by the principle of leverage, so that the reduction is size of the motor is achieved.

Also, the thrust load between the member and the shaft member which carries out the linear movement of the converting mechanism is reduced, so that downsizing of the bearing which supports the shaft member and the bracket which supports the bearing is achieved.

Specifically (see FIG. 2 and FIGS. 3A and 3B, for example), the converting mechanism (5) includes a sliding screw member (5a) which rotates on the basis of the rotation of the motor (4), and a nut member (5b) screwed directly on the sliding screw member (5a) and connected to a distal portion (6B) of the arm member (6), and the nut member (5b) carrying out the linear movement by the rotation of the sliding screw member (5a) causes the arm member (6) to pivot, so that the range shifting member (21) is shifted.

Accordingly, since the converting mechanism includes the sliding screw member and the nut member screwed directly to the sliding screw member and connected to the distal portion of the arm member, the configuration in which the nut member which carries out the linear movement and the arm member are connected at one position in comparison with the case in which, for example, the converting mechanism is composed of the ball screw mechanism and the member which carries out the linear movement is formed with a bifurcated portion which supports the screw member by clamping from both side surfaces in the radial direction to prevent the skewing, so that the arrangement of the motor between the converting mechanism and the proximal portion of the arm member is achieved easily.

Also, specifically (see FIG. 2, for example), a range position detecting sensor (11) connected to the proximal portion (6A) of the arm member (6) for detecting the position of the shift range on the basis of the pivotal angle of the arm member (6) is provided, and the range position detecting sensor (11) includes a first terminal (11a) for outputting signals and the motor (4) has a second terminal (4c) for wiring, and the first and second terminals (11a, 4c) are arranged close to each other.

Accordingly, since the first terminal and the second terminal are arranged close to each other, the wiring of the range position detecting sensor and the motor may be simplified.

Although the reference numerals in parentheses are shown for comparison with the drawings, it is only for facilitating understanding of the invention for the sake of convenience, and do not affect the configurations described in Claims.

Although not limited thereto, the range shifting apparatus according to the present invention may be used on the automatic transmission mounted on the vehicles such as passenger cars, trucks, buses, agricultural vehicles and, for example, it is suitable to be used in the shift-by-wire system which sets the shift range selected by the driver by the operation of the shift lever via the electric signal, and is suitable for vehicles in which downsizing of the range shifting apparatus is required.

### BRIEF DESCRIPTION OF THE DRAWINGS

FIG. 1 is a schematic drawing showing a range shifting apparatus and peripheral mechanisms according to an exemplary embodiment of the present invention.

FIG. 2 is a deployment of the range shifting apparatus.

FIGS. 3A and 3B show cross-sectional views illustrating the range shifting apparatus, in which FIG. 3A is a cross-sectional view taken along the line A-A in FIG. 2, and FIG. 3B is a cross-sectional view taken along the line B-B in FIG. 2.

### DESCRIPTION OF EXEMPLARY EMBODIMENTS

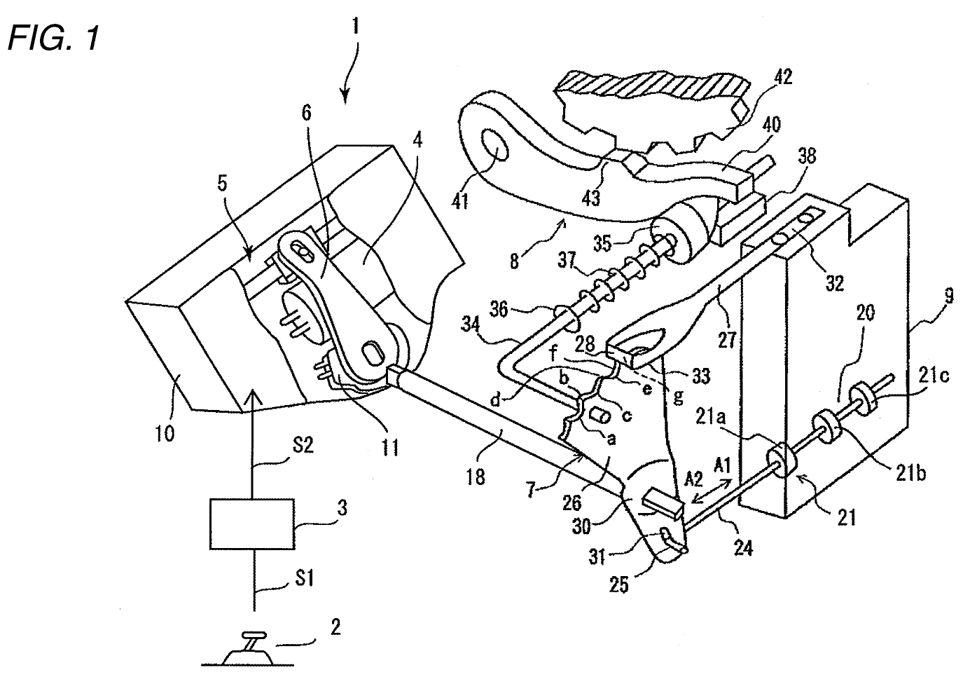

FIG. 1 shows a range shifting apparatus 1 according to this exemplary embodiment as an example of the range shifting apparatus according to the present invention. The same drawing schematically shows configurations of the range shifting apparatus 1, a detent mechanism 7, a parking mechanism 8, and a valve body 9.

The range shifting apparatus 1 is adapted to be mounted, for example, to an automatic transmission to be mounted on a vehicle (for example, a multi-gear automatic transmission or a continuously variable transmission (CVT)) as shown in FIG. 1. The range shifting apparatus 1 includes control means 3 for generating a control signal S2 on the basis of a shift signal (electric signal) SI from a shift lever (range selecting means) 2 whereby the shift range is selected by a driver, a motor 4 controlled on the basis of the control signal S2 from the control means 3, a converting mechanism (drive mechanism) 5 for converting a rotational movement of the motor 4 into a linear movement), an arm member (rotational engaging member, driving mechanism) 6 for converting the liner movement converted by the converting mechanism 5 into a pivotal movement, and a range position detecting sensor (detector) 11 for detecting the position of a spool 21 of a manual valve 20, described later, by detecting the rotational angle of a manual shaft (range shifting shaft) 18 driven by the arm member 6 to rotate. The motor 4, the converting mechanism 5, the arm member 6, and the range position detecting sensor 11 are stored in a same case (case member) 10.

In contrast, the automatic transmission roughly includes a hydraulic control device (valve body) 9 for controlling the hydraulic pressure of the transmission, not shown, a parking mechanism 8, and the detent mechanism 7. The detent mechanism 7 and the manual shaft 18 coupled to the detent mechanism 7 are disposed by being attached to the outside of the case of the automatic transmission, not shown. The spool 21 is arranged in the valve body 9 of the automatic transmission, and the parking mechanism 8 is stored in the case of the automatic transmission, not shown.

The shift lever 2 has indications of respective shift ranges (not shown) including P (parking) range, R (reverse) range, N (neutral) range, D (drive) range of the automatic transmission. The shift lever 2 is directly operated by a driver, and one of the above-described shift ranges is selected. Then, the shift signal S1 which corresponds to the selected range is generated. The range selecting means may be those other than the shift lever 2 as long as it can generate something which is able to reflect a will of the driver, that is, the shift signal S1 corresponding to the shift range selected by the driver. For example, a shift button, a shift switch, a voice input device or the like may be used.

The control means 3 is adapted to generate the control signal S2 on the basis of the shift signal S1 generated by the above-described shift lever 2 and control the rotation of the motor 4 descried later by the control signal S2. Furthermore, the control means 3 receives a supply of a detection signal from the range position detecting sensor 11 (describe later) which detects the position of the spool 21, described later. The control means 3 is adapted to control the direction of rotation of the motor 4 and the timing of starting and stopping of the rotation on the basis of the detection signal. In this manner, the control means 3 is control means for controlling the operation of the spool 21 by the motor 4 on the basis of the shift signal S1 from the shift lever 2 to shift the shift range, that is, a control unit for controlling a so-called shift-by-wire system (SBW). Although FIG. 1 shows the control means 3 being arranged outside the case 10, it may be arranged in the interior of the case 10.

In contrast, the detent mechanism 7 includes a detent lever 26, a detent spring 27, and a roller 28. The detent lever 26 is a plate-like member, and the manual shaft 18 is fitted to a bearing unit 30. The detent lever 26 is pivotably supported by a case of an automatic transmission (not shown) via the manual shaft 18. An elongated hole-shaped elongated hole 31 is formed at one end portion (lower end portion in FIG. 1) of the detent lever 26, and a hook 25 at the distal end of a connecting shaft 24 connected to the spool 21 is engaged with the elongated hole 31.

The spool 21 is a spool in the manual valve 20 arranged in the valve body 9, and includes, for example, lands 21a, 21b, 21c in sequence from the left side in the drawing. The spool 21 is supported so as to be movable in the axial direction (the direction indicated by an arrow A1 and A2), and is adapted to shift oil channels in the valve body 9 by moving in the axial direction to set to a predetermined shift range. In other words, it is adapted to be movable of P-position which corresponds to the P-range, R-position which corresponds to the R-range, N-position which corresponds to the N-range, and D-position which corresponds to the D-range.

Provided at the distal portion (upper end portion in FIG. 1) of the detent lever 26 are range grooves a, c, e, g in sequence from the left in the same drawing as four shift areas in sequence from the left. At portions between the individual range grooves a, c, e, g, projecting portions b, d, f are formed. The range grooves a, c, e, g roughly corresponding to the P-position, the R-position, the N-position, and the D-position of the spool 21 described above in this order. Here, the term “roughly” means that the range grooves a, c, e, g each are an area having a width (shift area). The detent spring 27 is formed of a substantially long panel-shaped member, a proximal portion 32 of which is fixed to the valve body 9 and a distal end of which is formed with a bifurcated portion 33 as shown in FIG. 1. The roller 28 is rotatably supported at the bifurcated portion 33. The entire detent spring 27 acts as a leaf spring, and is adapted to hold the detent lever 26 at a position with high degree of accuracy by pressing the roller 28 rotatably arranged at the distal end thereof against inclined surfaces of the respective range grooves a, c, e, g of the detent lever 26.

As described above, in this embodiment, the spool 21 is controlled with high degree of accuracy by controlling the rotational angle of the manual shaft 18 with high degree of accuracy instead of controlling the position of the spool 21 directly on the basis of the fact that the pivotal movement of the detent lever 26 and the movement in the direction of the arrows A1-A2 are in conjunction with each other. This is based on the fact that the rotational position of the manual shaft 18 and the position of the spool 21 have a one-to-one correspondence.

As shown in FIG. 1, the parking mechanism 8 includes a parking rod 34 bent into an L-shape on the proximal side and engaged with the detent lever 26 described above, a conical wedge 35 being loosely fitted to and being movable in the distal side of the parking rod 34, a spring 37 connected between a flange portion 36 fixed to the parking rod 34 and the wedge 35, a support 38 arranged below the distal side of the parking rod 34, and a parking pole 40 which is pivotable and allows the wedge 35 to be inserted into and retracted from a portion between the support 38 and the parking pole 40. The parking pole 40 is arranged so as to be pivotable substantially in the vertical direction about a proximal-side shaft 41 on the proximal side, and is provided with a claw 43 which is capable of being engaged with or disengaged from a parking gear 42 fixed to an output shaft (not shown) of the automatic transmission on the upper side thereof

Subsequently, an operation to shift the shift range will be described briefly taking the shift from the P-range to the R-range as an example. In the P-range, the roller 28 of the detent mechanism 7 is arranged in the range groove a in FIG. 1. When the driver shifts the shift lever 2 from the P-range to the R-range, the shift signal SI corresponding thereto is supplied to the control means 3. Then, the motor 4 of the range shifting apparatus 1, described later in detail, is rotated by the control means 3, the detent lever 26 rotates counterclockwise in FIG. 1 via the manual shaft 18, the spool 21 is moved in the direction indicated by the arrow Al, and the roller 28 enters the range groove c from the range groove a beyond the projecting portion b. The control means 3 stops the rotation of the motor 4 when the detected angle of the range position detecting sensor 11 described later reaches a value corresponding to the shift of the range from the P-range to the R-range. By the stop of the motor 4, the detent lever 26 is rotated by an urging force of the roller 28 on the basis of a resilient force of the detent spring 27. With this rotation, the roller 28 is positioned and retained in the range groove c with high degree of accuracy. Accordingly, the spool 21 at the position P is arranged at the R-position with high degree of accuracy, and the shift from the P-range to the R-range is achieved. The operations to shift between other shift ranges are the substantially same as those described above, the description is omitted.

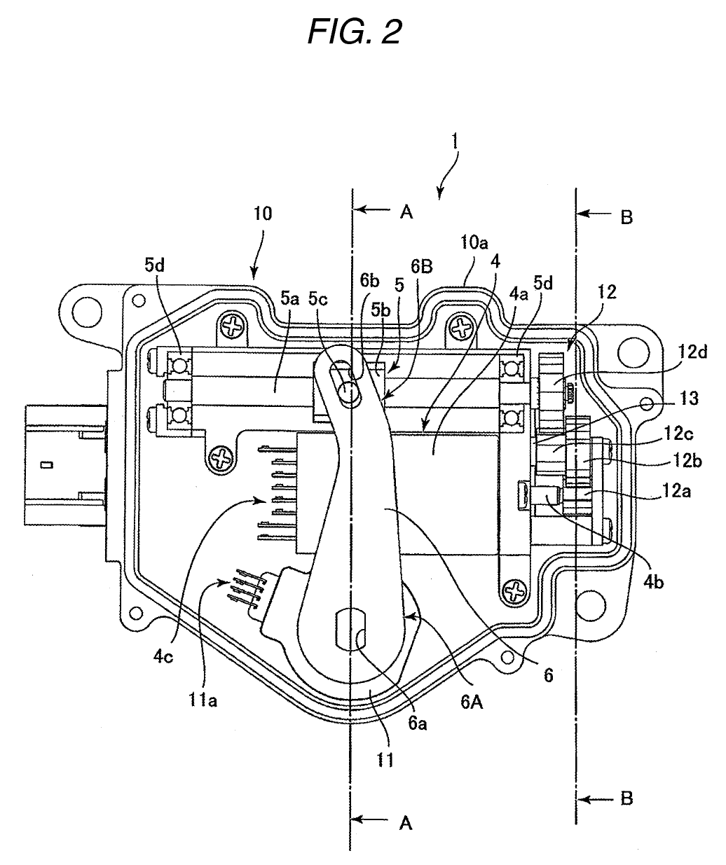

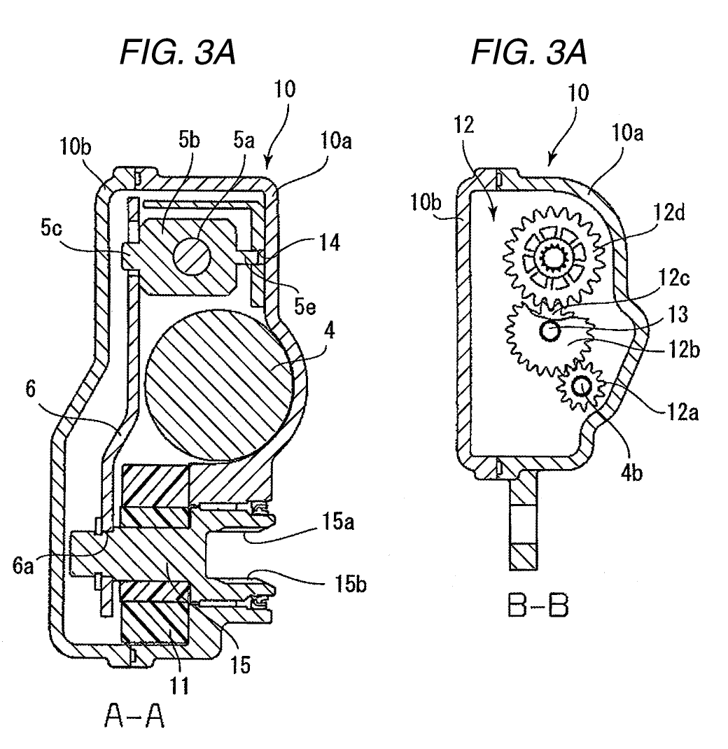

Referring now to FIG. 2 and FIGS. 3A and 3B, the configuration of the range shifting apparatus 1 according to an exemplary embodiment of the present invention will be described. The case 10 includes a case body 10a to be fixed to the automatic transmission and a cover 10b (see FIGS. 3A and 3B) for covering the case body 10a from above. FIG. 2 shows a state in which the cover 10b is removed. FIG. 3A shows a cross section taken along the line A-A in FIG. 2, and FIG. 3B is a cross section taken along the line B-B in FIG. 2.

As shown in FIG. 2, the motor 4 includes a cylindrical main body 4a, an output shaft 4b arranged on one side of the main body 4a (right side in FIG. 2) so as to project therefrom, and a motor terminal portion (second terminal) 4c arranged on the other end side of the main body 4a (left side in FIG. 2) for supplying a power and entering the control signal S2 from the control means 3. The motor 4 employs a DC motor having a permanent magnet for example, and the direction of rotation, the time of rotation, and the timing of rotation are controlled by the control means 3.

As shown in FIG. 2 and FIG. 3B, a transmission gear 12a is fixed to the output shaft 4b of the motor 4 so as to be rotated integrally therewith, and the transmission gear 12a is engaged with a transmission gear 12b. The transmission gear 12b is rotatably fitted to a transmission shaft 13 fixed to the case 10, and has an outer diameter larger than the transmission gear 12a, and a transmission gear 12c having a smaller outer diameter than the transmission gear 12b is integrally fixed thereto. Then, the transmission gear 12c meshes with a transmission gear 12d having a larger diameter than the transmission gear 12c, and the transmission gear 12d is fixed to the screw shaft 5a so as to rotate integrally with the screw shaft (screw member) 5a of the converting mechanism 5 described later. Accordingly, a rotational drive force of the output shaft 4b of the motor 4 is transmitted to the screw shaft 5a by being decelerated by a transmission gear group 12 including the transmission gears 12a, 12b, 12c, 12d.

The converting mechanism 5 employs a sliding screw in this embodiment. The sliding screw as the converting mechanism 5 includes a screw shaft 5a driven by the motor 4 to rotate and a nut member 5b engaged with the screw shaft 5a so as to be movable in the axial direction as shown in FIG. 2. The screw shaft 5a is rotatably supported by the case 10 via a bearing 5d fixed to the case 10 via a bracket.

The nut member 5b is formed into a substantially parallelepiped shape as shown in FIG. 3A, and is formed with a guide rail 5e on the back side (right side in FIG. 3A) along the axial direction. The guide rail 5e is fixedly arranged inside the case body 10a, and is loosely fitted to a guide groove 14 provided in parallel to the screw shaft 5a, and the nut member 5b is guided in the axial direction so as not to be rotatable in association with the rotation of the screw shaft 5a. On the near side of the nut member 5b (left side in FIG. 3A), there is formed a projecting portion 5c, and the projecting portion 5c is engaged with the arm member 6 described later. In this manner, in this embodiment, the converting mechanism 5 is configured to be able to convert the rotational movement into the linear movement. For example, the more the angle of the screw groove of the screw shaft 5a increases, the more the easiness of conversion of the linear movement of the nut member 5b into the rotational movement of the screw shaft 5a increases.

The arm member 6 includes a proximal portion 6A and a distal portion 6B as shown in FIG. 2. The distal portion 6B is formed with an elongated hole portion 6b which the projecting portion 5c of the nut member 5b engages. The proximal portion 6A is formed with a through hole 6a and, as shown in FIG. 3A, one end portion of a connecting member 15 is fitted to the through hole 6a. The connecting member 15 is arranged so as to be pivotable with respect to the case 10, and is fitted to the through hole 6a of the arm member 6 at one end portion thereof so as to prohibit the rotation. In other words, the connecting member 15 serves as a center axis of the pivotal movement of the arm member 6. The connecting member 15 is formed with a hole portion 15a on the other end portion thereof, and the hole portion 15a is formed with a spline 15b in the inner peripheral surface thereof for engaging the manual shaft 18 so as not to allow the relative rotation. Accordingly, the distal portion 6B of the arm member 6 pivots relative to the through hole 6a, that is, the connecting member 15 in association with the movement of the nut member 5b in the direction of axis of the screw shaft 5a, and this pivotal movement causes the manual shaft 18 to rotate via the connecting member 15. In FIG. 1, the range shifting apparatus 1 is viewed from the side where the arm member 6 is arranged for the sake of convenience. Actually, however, the one end portion of the manual shaft 18 is connected from the side of the motor 4 of the range shifting apparatus 1. In this embodiment, the connecting member 15 and the manual shaft 18 are spline-engaged in the description. However, for example, as shown in FIG. 1, it is also possible to configure the connecting member 15 and the manual shaft 18 so as not to allow the relative rotation by forming the one end portion of the manual shaft 18 so as to be square in cross section, and forming the hole portion of the connecting member 15 into a square shape which corresponds thereto.

The range position detecting sensor 11 is arranged in a state in which the connecting member 15 as the center axis of the pivotal movement of the arm member 6 is penetrated therethrough on the side of the proximal portion 6A of the arm member 6 as shown in FIG. 2 and FIG. 3A. The range position detecting sensor 11 according to this embodiment includes a potentiometer and is configured to output voltages corresponding to the pivotal angle of the arm member 6, that is, to the rotational angle of the manual shaft 18. The range position detecting sensor 11 includes a sensor terminal portion (first terminal) 11a for wiring for outputting the voltage corresponding to the rotational angle of the manual shaft 18, that is, the angle of the manual shaft 18 is outputted from the sensor terminal portion 11a to the control means 3 in the form of a signal. This angular signal is used by the control means 3 for a feedback control of the amount of rotation of the motor 4, that is, drive and shutdown of the motor 4 is controlled by the result of detection of the angle of the manual shaft 18 by the range position detecting sensor 11.

The sensor terminal portion 11a is arranged substantially leftward in FIG. 2, that is, the substantially same direction as the motor terminal portion 4c of the motor 4. Accordingly, the sensor terminal portion 1 la and the motor terminal portion 4c are arranged at the position in the vicinity of the motor terminal portion 4c, and also in the substantially same direction, so that the wiring to be connected thereto, that is, the wiring to be connected to the control means 3 is simplified. Although the range position detecting sensor 11 is described to be the potentiometer in this embodiment, the present invention is not limited thereto, and may be any sensor as long as it can output electric signals corresponding to the rotational angel of the manual shaft 18.

It is conceivable to employ a ball screw as the converting mechanism of the range shifting apparatus as in this embodiment. In this case, the ball screw is configured to have a ball screw shaft to be driven by the motor to rotate, a ball nut engaged with the ball screw shaft so as to be movable in the axial direction, and a number of balls interposed between the ball screw shaft and the ball nut, and the arm member must be formed with a bifurcated portion at the distal end thereof so as to be connected to the ball nut by clamping the ball screw shaft and the ball nut by the bifurcated portion. In other words, for example, when the ball nut and the arm member are connected at one position, the ball nut skews with respect to the ball screw shaft, and hence smooth rotation of the ball is impaired, so that the movement of the ball nut is impaired. However, in this embodiment, the sliding screw is employed, and hence the connection between the nut member 5b and the arm member 6 is achieved at one position. Accordingly, the arm member 6 may be arranged at a position far from the axial center of the screw shaft 5a in comparison with the case where the bifurcated portion is formed at the distal side, and the motor 4 may be arranged between the proximal portion 6A of the arm member 6 and the screw shaft 5a. Also, since the bifurcated portion is not formed on the distal side, the screw shaft 5a and the motor 4 may be arranged close to each other, so that downsizing of the range shifting apparatus 1 is achieved.

As described thus far, the range shifting apparatus 1 according to the exemplary embodiment of the present invention is configured in such a manner that the motor 4 is arranged between the proximal portion 6A of the arm member 6 and the converting mechanism 5, and the axial direction of the converting mechanism 5 and the axial direction of the motor 4 are oriented in parallel to each other, the axial length thereof may be reduced, so that the downsizing of the range shifting apparatus 1 is achieved.

Also, since the length of the arm member 6 is formed to be longer by the radial dimension of the motor 4 than the case in which the proximal portion 6A of the arm member 6 and the converting mechanism 5 are arranged adjacently, a large amount of the linear movement of the converting mechanism 5 is secured for the pivotal angle of the proximal portion 6A, and hence the pivotal angle of the proximal portion 6A can be controlled with high degree of accuracy. In addition, the torque inputted to the converting mechanism 5 is reduced by an amount corresponding to the increase of the length of the arm member 6 by the principle of leverage, so that downsizing of the motor 4 is achieved.

Also, the thrust load between the nut member 5b and the screw shaft 5a which carries out the linear movement of the converting mechanism 5 is reduced, so that downsizing of the bearing 5d which supports the screw shaft 5a and the bracket which supports the bearing 5d is achieved.

Furthermore, since the converting mechanism 5 includes the sliding screw member and the nut member 5b screwed directly to the sliding screw member and connected to the distal portion 6B of the arm member 6, the configuration in which the nut member 5b which carries out the linear movement and the arm member 6 are connected at one position in comparison with the case in which, for example, the converting mechanism 5 is composed of the ball screw mechanism and the member which carries out the linear movement is formed with the bifurcated portion which supports the screw member by clamping from both side surfaces in the radial direction to prevent the skewing, so that the arrangement of the motor 4 between the converting mechanism 5 and the proximal portion 6A of the arm member 6 is achieved.

Also, since the sensor terminal portion 11a and the motor terminal portion 4c are arranged close to each other, the wiring of the range position detecting sensor 11 and the motor 4 may be simplified.

In this embodiment described thus far, the case of mounting the range shifting apparatus 1 to the automatic transmission has been described. However, the present invention is not limited thereto, and it may be used as the shifting apparatus for the parking mechanism which does not shift the hydraulic range, for example, as the case of the hybrid vehicle.

What is claimed is:

1. A range shifting apparatus which achieves a predetermined shift range selected from a plurality of shift ranges by shifting a range shifting member on the basis of an electric signal, the apparatus comprising:
a motor controlled on the basis of a signal from a range selecting mechanism which selects the shift ranges;
a converting mechanism which converts a rotational drive force of the motor to a drive force of a linear movement; and
an arm member for converting the drive force of the linear movement converted by the converting mechanism into a drive force of a pivotal movement,
wherein the motor is arranged between the converting mechanism and a proximal portion of the arm member, which is a pivotal center of the pivotal movement.

2. The range shifting apparatus according to claim 1, wherein the converting mechanism includes a sliding screw member which rotates on the basis of the rotation of the motor, and a nut member screwed directly on the sliding screw member and connected to a distal portion of the arm member, and the nut member carrying out the linear movement by the rotation of the sliding screw member causes the arm member to pivot, so that the range shifting member is shifted.

3. The range shifting apparatus according to claim 1, further comprising a range position detecting sensor connected to the proximal portion of the arm member for detecting the position of the shift range on the basis of the pivotal angle of the arm member,
wherein the range position detecting sensor includes a first terminal for outputting signals and the motor has a second terminal for wiring, and the first and second terminals are arranged close to each other.

4. The range shifting apparatus according to claim 2, further comprising a range position detecting sensor connected to the proximal portion of the arm member for detecting the position of the shift range on the basis of the pivotal angle of the arm member,
wherein the range position detecting sensor includes a first terminal for outputting signals and the motor has a second terminal for wiring, and the first and second terminals are arranged close to each other.
